(19) United States
(12) Patent Application Publication
(10) Pub. No.: US 2016/0019143 A1
(43) Pub. Date: Jan. 21, 2016

(54) GARBAGE COLLECTION FOR SELECTING REGION TO RECLAIM ON BASIS OF UPDATE TO REFERENCE SOURCE INFORMATION

(71) Applicant: Hitachi, Ltd., Tokyo (JP)

(72) Inventors: Ryozo Yamashita, Tokyo (JP); Motoki Obata, Tokyo (JP); Hiroyasu Nishiyama, Tokyo (JP)

(21) Appl. No.: 14/424,063

(22) PCT Filed: Feb. 25, 2013
(86) PCT No.: PCT/JP2013/054662

§ 371 Date: Feb. 26, 2015

(51) Int. Cl. G06F 12/02

(52) U.S. Cl. CPC G06F 12/0261; G06F 2212/702

(57) ABSTRACT

In a GC processing in which a memory area is managed by being divided, collection efficiency of an area is further optimized. In order to realize the technology, a calculator including an arithmetic unit and a memory includes a storage unit which stores reference source information of data which is stored in a plurality of storage areas which are allocated to the memory in each of the storage areas; and a control unit which determines a storage area in which updated reference source information is different from reference source information which is recorded in the storage unit to be an area as a release target.

### TECHNICAL FIELD

The present invention relates to a calculator, a recording medium, and a memory managing method, and relates to a calculator which performs managing of a memory of a calculator, a recording medium, and a memory managing method.

### BACKGROUND ART

In a calculator system, as implicit collection means of an object in a memory which is used in a program, there is a garbage collection (hereinafter, referred to as GC) technology. A Java (registered trademark) virtual machine (hereinafter, referred to as JVM) is one of representative processing systems in which GC is adopted.

In GC, an unnecessary object (hereinafter, referred to as dead object) is found by checking reference relations of objects in a memory, and an automatic collection is executed. Specifically, GC processing is performed by tracing reference relations of an object in a memory from a source (hereinafter, referred to as reference route) in which a program can trace a reference, and by determining an object of which tracing could not reach the end as a dead object, and collecting the dead objects. In GC in the related art, a method of checking the entire memory area which is used at one time is adopted, and in this method, a processing time which is proportional to a memory amount is necessary.

In recent years, increase in capacity of a memory which is mounted on a calculator has progressed, and accordingly, there has also been a tendency for processing time of GC to increase. GC is roughly classified into a Stop the World method, and a Concurrent method. In the Stop the World method, processing of a program is stopped while the GC processing is performed. For this reason, an increase in GC time leads to stopping of the program for a long time which is not intended, and there is a concern that availability of a calculator system may remarkably deteriorate. On the other hand, in the Concurrent method, since the GC processing is performed in parallel to processing of the program, a stop time reduces; however, there is a problem in that an execution performance of the program deteriorates (NPL 1).

A GC method in which the entire memory area is divided into a plurality of small areas instead of being processed at one time, and is processed in respective small areas in order to solve the above described problem which is associated with a large capacity of a memory has been proposed (NPL 2) (PTL 1). When adopting the method, since an amount of a memory area to be processed at one time is reduced, it is possible to prevent stopping of a program for a long time even when the Stop the World method is used.

In addition, in the GC technology in which a memory area is processed by being divided into a plurality of small areas, it is known that efficient GC processing is performed by including an auxiliary structure which is referred to as a barrier set for indicating a portion of which a value is changed in the memory area (NPL 1).

In addition, as a memory managing method in the related art, there also is a method of dividing a memory area into a plurality of small areas in order to explicitly manage the memory area from a program (PTL 2). In addition, there is a method in which an automatic collection process with respect to an unnecessary area which is present in respective small areas is performed in parallel with respect to the method (PTL 3).

### CITATION LIST

### Patent Literature

PTL 1: U.S. Pat. No. 7,340,494
PTL 2: JP-A-2009-37547
PTL 3: JP-A-2011-53862

### Non-Patent Literature

NPL 1: “Garbage Collection: Algorithms for Automatic Dynamic Memory Management” (Richard Jones, Rafael Lins, 1996, John Wiley & Sons Inc, ISBN: 978-0471941484)
NPL 2: I Richard L. Hudson, “Incremental collection of mature objects, In Proceedings of the International Workshop on Memory Management, pp. 388-403”, 1992

### SUMMARY OF INVENTION

### Technical Problem

When a memory area is divided into a plurality of small areas, which small area is to be selected as a processing target of GC is important in order to enhance a performance of a calculator system.

In general, a distribution of unnecessary areas in the memory area is not uniform. For this reason, there is a possibility that only small areas with a small unnecessary area are selected depending on a selection method. In this case, since unnecessary areas which can be collected in one GC processing are small, it is necessary to perform the GC processing a plurality of times, and this leads to a deterioration in performance of the calculator system. In contrast, when it is possible to select only small areas with a plurality of unnecessary areas, unnecessary areas which can be collected in one GC processing increases. For this reason, the number of execution times of the GC processing is reduced, and it is possible to enhance the performance of the calculator system.

As a method of selecting a small area, a method of selecting all of small areas in regular order is disclosed in NPL 2. In such a case, since all of small areas are selected at equal frequency, there is a concern that only small areas with small unnecessary area may be consecutively selected. However, there still is a problem when considering a load in the selection process, in order to equally select (check) all of small areas by also including a small area of which collection efficiency is not good, and the performance of the calculator system deteriorates to that extent.

In addition, a technology in which it is possible to select small areas with a plurality of unnecessary areas by checking an amount of the unnecessary area in each small area using GC of the Concurrent method, as another selection method of a small area is disclosed in PTL 1. However, also in this case, since GC of the Concurrent method is used in parallel, there is a problem of deterioration in performance similarly to GC of a common Concurrent method. In GC processing in which a memory area is managed by being divided, further optimization of collection efficiency of an area is desired.

### Solution to Problem

In order to solve the above-described problem, for example, the invention described in claims is applied. That is, a calculator including an arithmetic unit and a memory which includes a storage unit which stores reference source information of data which is stored in a plurality of storage areas which are allocated to the memory in each of the storage areas; and a control unit which determines a storage area in which updated reference source information is different from reference source information which is recorded in the storage unit to be an area as a release target is applied.

### Advantageous Effects of Invention

According to one aspect of the present invention, it is possible to select an area of a release target more efficiently, using a change in a reference source in an area when selecting an area as a GC processing target.

Other problems and effects of the present invention will become clear in the following descriptions.

### BRIEF DESCRIPTION OF DRAWINGS

FIG. 1 is a block diagram which illustrates a configuration example of the calculator in a first embodiment to which the present invention is applied.

FIG. 2 is a schematic diagram which illustrates a configuration example of a heap area according to the embodiment.

FIG. 3A is a diagram which schematically illustrates an example of information for managing reference source information according to the embodiment.

FIG. 3B is a diagram which schematically illustrates a relationship between the information for managing reference source information and an object in a heap area according to the embodiment.

FIG. 4 is a flowchart which illustrates a flow of a recording process of reference source information using a Java program execution unit according to the embodiment.

FIG. 5 is a flowchart which illustrates a flow of a selection process of a GC target using reference source information using a GC processing unit according to the embodiment.

FIG. 6 is a block diagram which illustrates a configuration example of a calculator according to a second embodiment.

FIG. 7 is a schematic diagram which illustrates barrier set information according to the second embodiment.

FIG. 8A is a schematic diagram which illustrates an example of information for managing reference source information according to the second embodiment.

FIG. 8B is a diagram which schematically illustrates a relationship between the information for managing reference source information according to the second embodiment and an object on a heap area.

FIG. 9 is a flowchart which illustrates a flow of a recording process of reference source information using a Java program execution unit according to the second embodiment.

FIG. 10 is a flowchart which illustrates a flow of a selection process of a GC target using reference source information using a GC processing unit according to the second embodiment.

### DESCRIPTION OF EMBODIMENTS

### First Embodiment

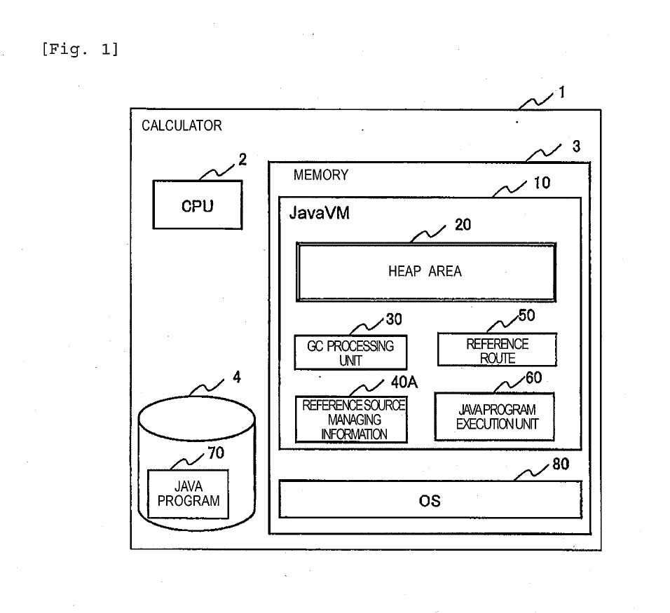

FIG. 1 illustrates a configuration of a calculator 1 according to a first embodiment to which the present invention is applied. According to the embodiment, an example in which a Java VM 10 functions in the calculator 1 is used.

In the calculator 1, a general-purpose server device in which a CPU 2, a memory 3, and a storage unit 4 are provided is used. The CPU 2 executes the Java VM 10 in the memory 3 in cooperation with a Java program 70 and an OS 80. In addition, in the Java VM 10, a GC processing unit 30, and a Java program execution unit 60 are executed, and reference source managing information 40A, and a reference route 50 are held.

A heap area 20 is allocated to the memory 3 using the OS 8.

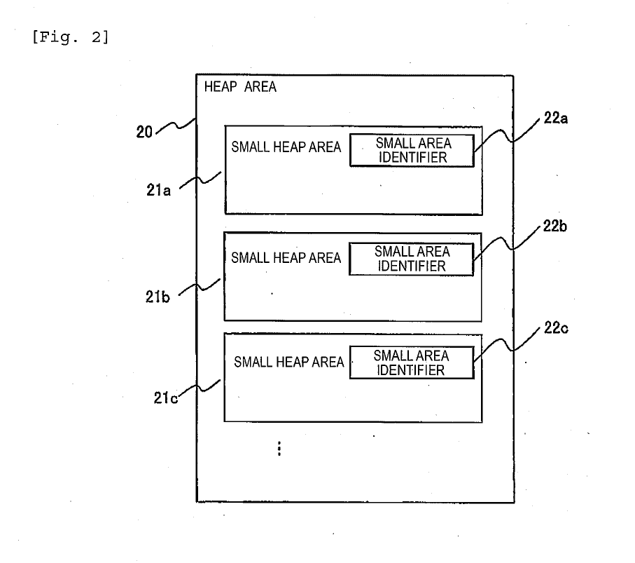

FIG. 2 schematically illustrates a configuration of the heap area 20. In the heap area 20, an arbitrary numbers of small heap areas 21a to 21c are provided. The number or size of small heap areas 21 included in the heap area 20 may be changed in a process of executing the Java VM 10 using the CPU 2. In addition, the small heap areas 21 are managed by small area identifiers 22a to 22c, respectively, and respectively different values are registered in small area identifiers 22.

In addition, the heap area 20 may include an area other than the small heap area 21. In addition, the small heap area 21a, or the like, in the heap area 20 may be an area which can be explicitly managed from a program as disclosed in above described PTL 3. More specifically, the heap area 20 may be Java heap, and all or a part of the small heap areas 21 may be an external heap area.

The Java program execution unit 60 secures an object which is necessary in the middle of executing the Java program 70 in the small heap area 21a, or the like. In addition, the Java program execution unit 60 stores reference information with respect to an object in the small heap area 21 in the reference route 50, and operates the object.

In the reference source managing information 40A, each of small heap areas 21a to 21c, and an object name of a reference source thereof are managed by being correlated with each other. In the calculator 1, when a reference source object name at a time of GC processing, and an object name of a reference source at a time of generating the object which is recorded in the reference source managing information 40A are different from each other, the small heap area 21 is determined to be a release target. That is, there is a high possibility that an area in which a change occurs in reference relations of data is an unnecessary area, and in particular, it is possible to assume that an unnecessary object is stored in the small heap area 21 in which a reference source object name at a time of generating data is deleted, due to a change in reference relations of data.

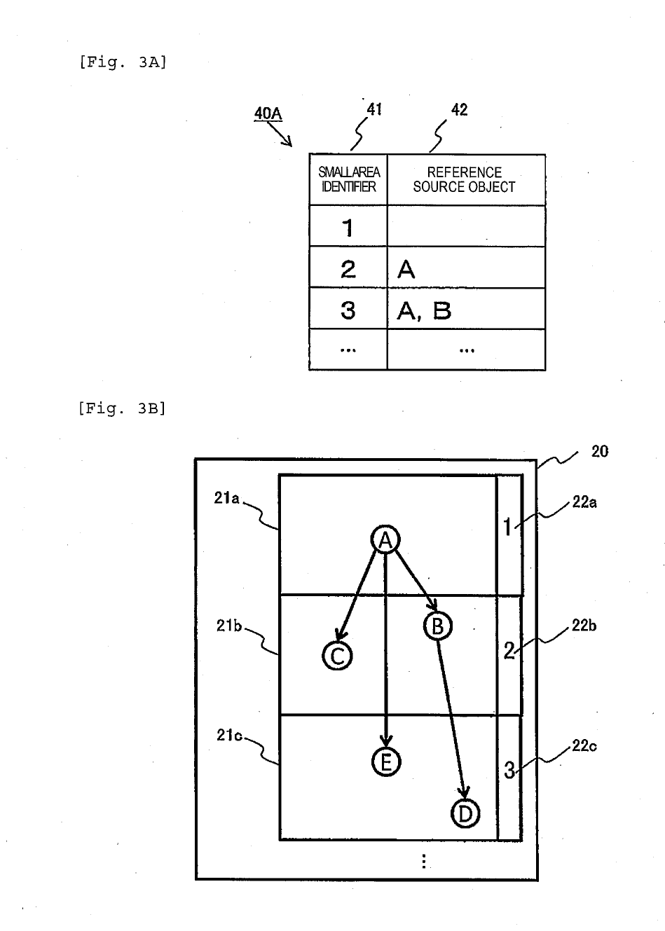

FIGS. 3A and 3B schematically illustrate a configuration of the reference source managing information 40A, and an example of data. The reference source managing information 40A is, for example, information in a form of a table, and includes an identifier field 41, and a reference source object field 42. The same number of rows as those of the small heap area 21 are included in the reference source managing information 40A, and each row corresponds to one small heap area 21. In the identifier field 41, a value of the small area identifier 22 of a corresponding small heap area 21 is maintained. In the reference source object field 42, identification information of an object (object ID, or the like) which refers to the inside of a corresponding small heap area 22 is maintained.

For example, as illustrated in FIG. 3B, a small heap area 21b of which a value of a small area identifier 22b is “2” stores an object B and an object C, and when the objects B and C are referred to from an object A, the objects are included in a row of which the small area identifier field 41 is “2”, and the reference source object field is “A” in the reference source managing information 40A. In addition, when objects D and E are stored in the small heap area 21c of which a value of the small area identifier 22c is “3”, and the objects D and E are referred to from the object A or the object B, respectively, the objects D and E are included in a row of which the small area identifier field 41 is “3”, and the reference source object field 42 is A and B, in the reference source managing information 40A.

In the GC processing unit 30, an object which is not used in the heap area 20 is specified by tracing reference relations of an object which is stored in the reference route 50, and a corresponding memory area is released. In addition, the GC processing unit 30 is invoked when the Java program execution unit 60 fails in securing of an object in the small heap area 21a, or the like, (for example, memory leaking), and starts the GC processing. In addition, a trigger for invoking the GC processing unit 30 using the Java program execution unit 60 is not limited to this.

Hitherto, the configuration of the calculator 1 according to the embodiment has been described. Subsequently, a “recording process of reference source information”, and a “selection process of GC target using reference source information” which are one of characteristics of the calculator 1 will be described.

The Java program execution unit 60 changes the reference source managing information 40A when a reference between objects which are stored in the small heap area 21a, or the like, is changed. In addition, the GC processing unit 30 selects the small heap area 21a, or the like, which is a processing target based on the reference source managing information 40A when receiving a notification from the Java program execution unit 60. An unused object which is collected in the GC processing using the GC processing unit 30 is limited to an object in the selected small heap area 21a, or the like, and an object in a small heap area other than that is not collected even when the object is not used.

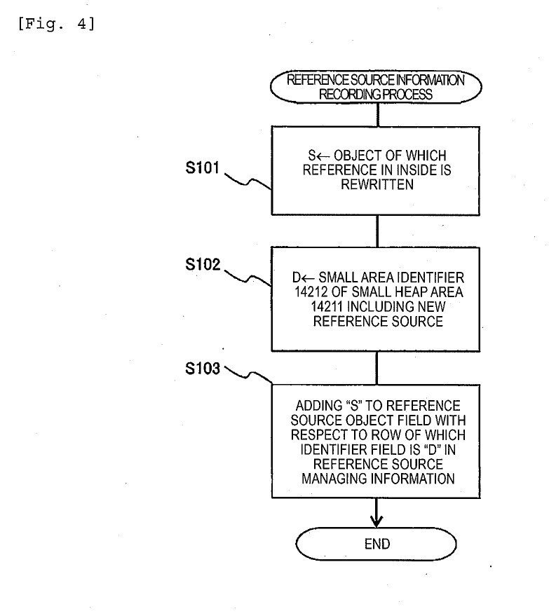

FIG. 4 illustrates a flow of the “recording process of reference source information” in which the reference source managing information 40A is changed by the Java program execution unit 60.

First, the Java program execution unit 60 starts the process at a predetermined timing such as a point in time at which a reference in an object which is stored in each small heap area 21, or the like, is changed in the middle of executing the Java program 70.

In S101, the Java program execution unit 60 substitutes an object of which a reference stored inside is changed for a variable S.

In S102, the Java program execution unit 60 substitutes the small area identifier 22 corresponding to the small heap area 21 including a heap position which is indicated by a new reference after change for a variable D.

In S103, the Java program execution unit 60 adds “S” to the reference source object field 42 with respect to a row of which the small area identifier field 41 is “D” in the reference source managing information 40A. The Java program execution unit 60 ends the flow of the process thereafter.

In addition, when “S” is included in the reference source object field 42 of the row in advance, there is no operation to be performed. Also in a case in which “S” is included in the small heap area 21 of which small area identifier 22 corresponds to “D”, there is no operation to be performed.

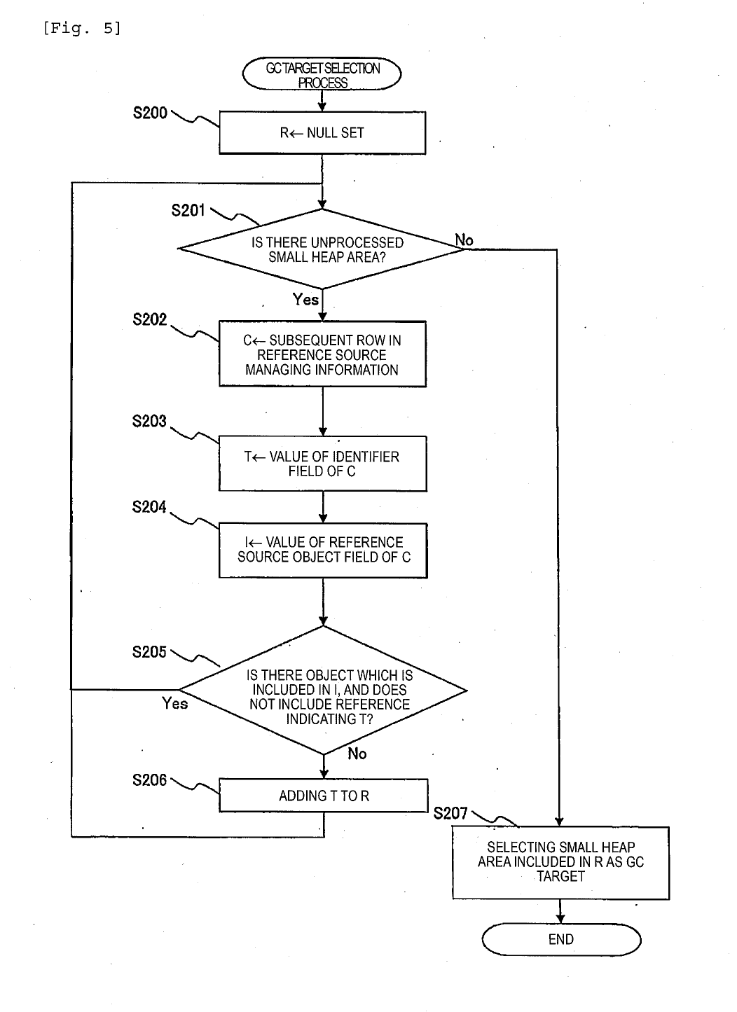

Subsequently, FIG. 5 illustrates a flow of a “selection process of GC target using reference source information”. The process is a process for selecting the small heap area 21a, or the like, which is a processing target based on the reference source managing information 40A using the GC processing unit 30. The GC processing unit 30 starts the flow of the process at a predetermined timing such as a point in time of receiving a notification from the Java program execution unit 60.

In S200, the GC processing unit 30 initializes a variable R to a null set.

In S201, the GC processing unit 30 checks whether or not there is an unprocessed small heap area in all of the small heap areas in the reference source managing information 40A. When there is an unprocessed small heap area (Yes in S201), the process proceeds to S202, and when there is no unprocessed small heap area (No in S201), the process proceeds to S209.

In S202, the GC processing unit 30 sets the subsequent row in the reference source managing information 40A to a variable C.

In S203, the GC processing unit 30 sets a value of the small area identifier field 41 in the variable C to a variable T.

In S204, the GC processing unit 30 sets a value of the reference source object field 42 in the variable C to a variable I.

In S205, the GC processing unit 30 checks whether or not a reference included in all of objects in the variable I indicates the inside of T with respect to the objects. When there is an object which does not include such a reference (No in S205), the GC processing unit 30 adds “T” to the variable R in S206, and the process returns to S201. When there is not the above-described object (Yes in S205), the process returns to S201.

In S207, the GC processing unit 30 selects a small heap area which is included in R as a GC target area.

In addition, a condition of determining whether or not to add “T” to the variable R by the GC processing unit 30 in S205 is not limited to the above-described condition. For example, “T” may be added to the variable R when the number of objects which do not include such a reference exceeds a threshold value which is designated by an API for a Java program, an option when starting the Java VM 10, an external file, or the like, by checking whether or not a reference included in all of objects in the variable I indicates the inside of “T” with respect to the objects. Alternatively, the GC processing unit 30 may perform the addition only when the number of elements of the variable R does not reach the maximum number of elements, by maintaining the maximum number of elements which is designated by the API for a Java program, an option when starting the Java VM 10, an external file, or the like.

As described above, according to the calculator 1 in the first embodiment, it is possible to select the small heap area 21 which is a release target more efficiently using a change in reference source object name. That is, since it is not necessary to check reference relations by setting all of small heap areas 21a to 21c as candidates of the release target to specify an unnecessary area, it is possible to expect high speed processing to that extent, and there is an effect of reducing a processing load.

In particular, since the calculator 1 selects a small heap area which is assumed to be an unnecessary area (area storing only an unnecessary object or a plurality of unnecessary objects) due to changing of a reference source to another small heap area 21, or deleting as a release target area, there also is an effect of improving efficiency of area collecting in the release processing.

### Second Embodiment

In the “selection process of GC target using reference source information” according to the first embodiment, checking of a reference in all of objects stored in the reference source object field 42 in the reference source managing information 40A is performed.

When there are a plurality of reference source objects with respect to each small heap area 21, it is also assumed that the number of objects which are stored in the reference source object field 42 increases. In a calculator system 200 according to a second embodiment, one of characteristics is that a processing time is shortened due to a more efficient selection process, and an execution performance of a program is improved. More specifically, the selection process is efficiently performed using a barrier set.

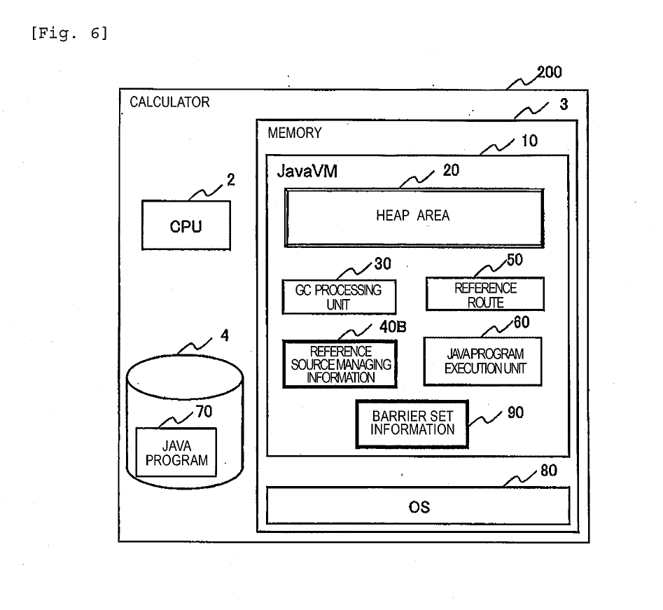

FIG. 6 illustrates a configuration example of the calculator system 200. A main difference from the first embodiment is that barrier set information 90 is maintained in a Java VM 142, and reference source managing information 40B in which an existing reference source barrier set, or a newly added reference source barrier set is managed is maintained instead of the reference source managing information 40A. Since other configurations are the same as those of the first embodiment, detailed descriptions will be omitted.

The barrier set information 90 is information which manages whether or not there is a change in each barrier set area when the heap area 20 is divided into areas with a fixed length (hereinafter, referred to as “barrier set area”). An area length of the barrier set area may be set to an appropriate fixed value, or a value which is designated by the API for a Java program, an option when starting the Java VM 10, an external file, or the like.

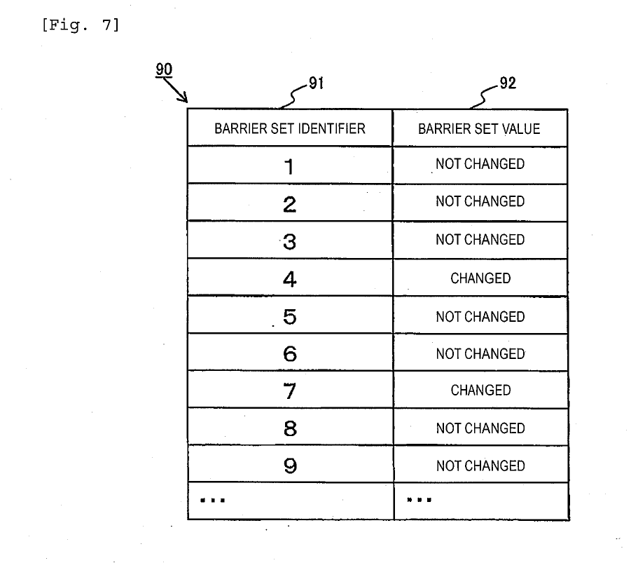

FIG. 7 schematically illustrates a configuration of the barrier set information 90 and an example of data. The barrier set information 20 includes a barrier set identifier field 91, and a barrier set value field 92. The barrier set information 90 includes the same number of rows as those of the barrier set area in the heap area 20, and each row corresponds to one barrier set area. The barrier set identifier field 91 maintains a value which uniquely identifies a corresponding barrier set area (hereinafter, referred to as “barrier set identifier”). The barrier set value field 92 maintains a value indicating whether or not there is a change in a corresponding barrier set area.

When a length of the small heap area 21 is an integer multiple (including one time) of a length of a barrier set area, it is possible to select an area more efficient in the selection process, since information stored in the barrier set information 90 becomes more accurate. For this reason, it is desirable to set the length of the barrier set area to 1/integer of the length of the small heap area 21a, or the like.

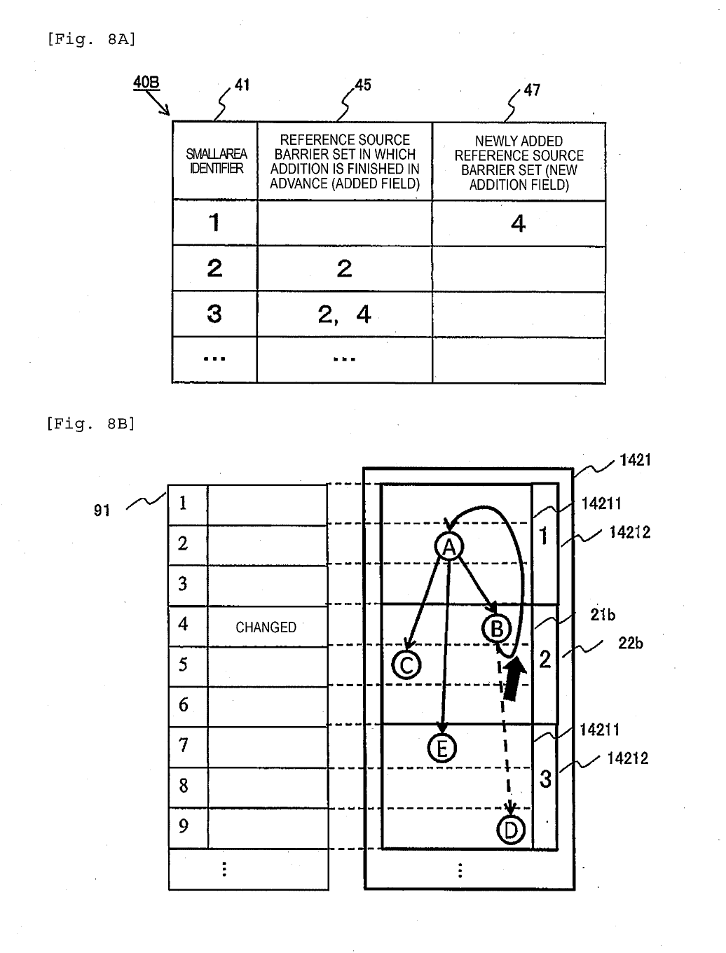

FIG. 8A schematically illustrates a configuration of the reference source managing information 40B according to the second embodiment and a data example. The reference source managing information 40B includes a field 45 for registering a reference source barrier set which is added in advance (hereinafter, referred to as “added field 45”), and a field 47 for registering a reference source barrier set which is newly added (hereinafter, referred to as “new addition field 47”).

Both the fields are formed of barrier set identifiers of 0 or more.

A barrier set identifier which is included in the added field 45 is an identifier including an object which refers to the inside of the small heap area 21a, or the like, corresponding to the row in a corresponding barrier set area, at a point in time at which a selection process of the GC target area is finally performed.

The barrier set identifier which is included in the new addition field 47 is an identifier in which a reference to the corresponding small heap area 21a, or the like, corresponding to the row is written in a corresponding barrier set area, after a point in time at which a selection process of the GC target area is finally performed.

For example, as illustrated in FIG. 8B, objects B and C are stored in the small heap area 21b of which a value of the small area identifier 22b is “2” at a point in time at which a selection process of a GC target is finally performed. Since the objects B and C are referred to from an object A in the barrier set area of which the barrier set identifier is “2”, the reference source managing information 40B includes a row in which the small area identifier field 41 is “2”, and the added field 45 is “2”.

In addition, objects D and E are stored in the small heap area 21c in which a value of the small area identifier 22c is “3” at a point in time at which a selection process of a GC target is finally performed. Since the respective objects D and E are referred to from an object A in the barrier set area in which the barrier set identifier is “2”, and an object B in the barrier set area in which the barrier set identifier is “4”, the reference source managing information 43B includes a row in which the small area identifier field 41 is “3”, and the added field 45 is “2” and “4”.

In addition, when a reference with respect to the object D from the object B is changed to a reference from the object B to the object A after a point in time at which a selection process of a GC target is finally performed, the reference source managing information 40B includes a row in which the small area identifier field 41 is “1”, and the new addition field 47 is “4”.

In addition, the added field 45 and the new addition field 47 of the reference source managing information 40B may be set to one field in a lump; however, a method of managing the fields separately is efficient, and is preferable. That is, the reason for this is that, it is possible to more efficiently use the value in the barrier set information 90 when being managed in a dividing manner, since it is clear that a value of the barrier set value field 92 in the barrier set information 90 is normally “changed” in the barrier set area which is changed after a point in time at which the selection process of the GC target is finally performed.

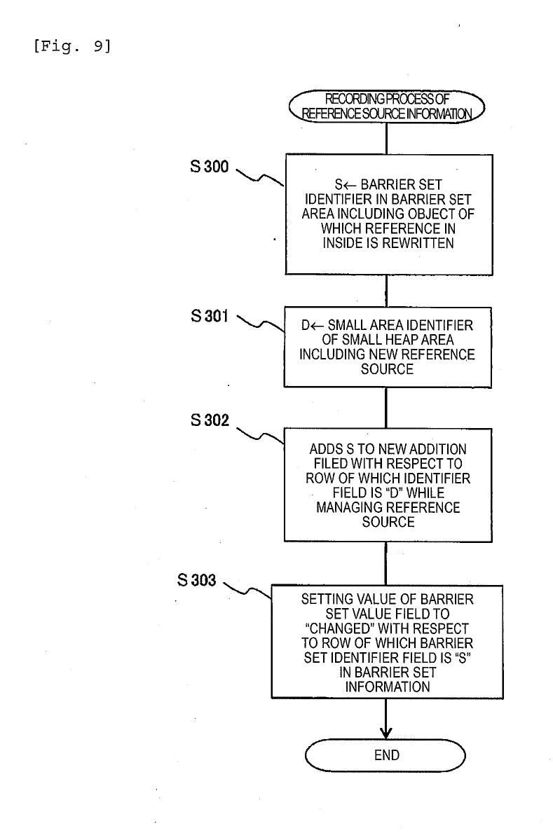

FIG. 9 illustrates a flow of the “recording process of reference source information” when the Java program execution unit 50 of the calculator 200 changes the reference source managing information 40B.

First, the Java program execution unit 50 starts the process at a predetermined timing such as a point in time at which a reference in an object stored in each small heap area 21 is changed in the middle of executing the Java program 70.

In S300, the Java program execution unit 60 substitutes a barrier set identifier in a barrier set area including an object of which a reference which is stored inside is changed for a variable S.

In S301, the Java program execution unit 60 substitutes the small area identifier 22 corresponding to the small heap area 21 including a heap position which is indicated by a new reference after change for a variable D.

In S302, the Java program execution unit 60 adds “S” to the new addition field 47 with respect to a row in which the small area identifier field 41 is “D” in the reference source managing information 40B.

In addition, when “S” is included in the new addition field 47 of the row in advance, there is no operation to be performed. In addition, also in a case in which “S” is included in the small heap area 21 in which the small area identifier 41 corresponds to “D”, there is no operation to be performed.

In S303, the Java program execution unit 60 sets a value of the barrier set value field 92 to “changed” in a row of which the barrier set identifier field 91 is “D” in the barrier set information 90. Thereafter, the Java program execution unit 60 ends the flow of the process.

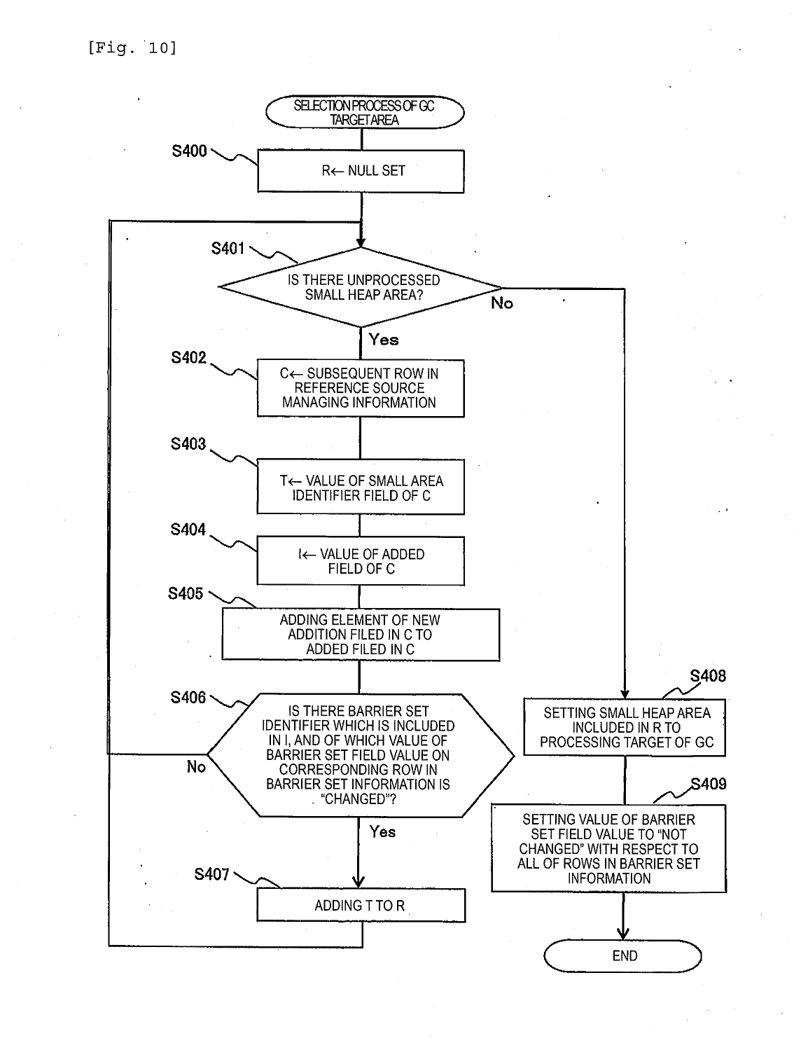

In the second embodiment, FIG. 10 illustrates a flow of the “selection process of GC target using reference source information” when the GC processing unit 30 selects the small heap area 21a, or the like, as a processing target based on the reference source managing information 40B. In the process, processes of S404, S405, S406, and S409 are different from the “selection process (FIG. 5)” in the first embodiment, and steps other than those are the same.

In S400, the GC processing unit 30 initializes the variable R to a null set.

In S401, the GC processing unit 30 checks whether or not there is an unprocessed area in all of small heap areas in the reference source managing information 40B. When there is an unprocessed area (Yes in S401), the process proceeds to S402, and when there is no unprocessed area (No in S401), the process proceeds to S408.

In S402, the GC processing unit 30 sets the subsequent row in the reference source managing information 40B to a variable C.

In S403, the GC processing unit 30 sets a value of the small area identifier field 41 in the variable C to a variable T.

In S404, the GC processing unit 30 sets a value of the added field 45 in the variable C to a variable I.

In S405, the GC processing unit 30 adds an element of the new addition field 47 in C to the added field 45 in C, and sets a value of the new addition field 47 to an empty value. In addition, an addition to an element included in the added field 45 may not be performed.

In S406, the GC processing unit 30 checks a row to which the barrier set information 90 corresponds with respect to all of barrier set identifiers in the variable I, and checks whether or not there is a barrier set identifier in which a value of the barrier set value field 92 of the corresponding row is “changed”. When there is an object of which the value of the barrier set value field 92 is “changed” (Yes in S406), the GC processing unit 30 proceeds to S407, and returns to S401 by adding “T” to the variable R. When there is no such object (No in S406), the process returns to S201. In addition, similarly to the step S205 in FIG. 5, a condition of determining whether or not “T” is to be added to the variable R by the GC processing unit 30 is not limited to the above-described condition.

In S407, the GC processing unit 30 selects a small heap area which is included in “R” as a GC target area.

Thereafter, in S408, the GC processing unit 30 sets a value of the barrier set value field 91 to “not changed” with respect to all of rows in the barrier set information 90, and ends the process.

In this manner, according to the calculator 200 according to the second embodiment, it is possible to efficiently select a release target area, when there are a plurality of reference source objects with respect to each small heap area 14211.

Hitherto, embodiments of the present invention have been described; however, the invention is not limited to the above-described various examples, and it is possible to apply various configurations, or the like, without departing from the scope of the invention. For example, in the above-described example, each function unit is exemplified as a function unit which functions due to cooperation between the CPU and the program; however, it is also possible to configure a part thereof as hardware. It is also possible to switch a sequential order of various processes.

In addition, various programs in the embodiments can be stored in a portable non-transitory electronic, electrical, and/or magnetic recording medium, or can be downloaded and installed through a network such as the Internet.

### REFERENCE SIGNS LIST

1, 200: calculator
70: Java program
10: Java VM
20: heap area
30: GC processing unit
40A, 40B: reference source managing information
50: reference route
60: Java program execution unit
90: barrier set information

1. A calculator which includes an arithmetic unit and a memory, the calculator comprising:
a storage unit which stores reference source information of data which is stored in a plurality of storage areas which are allocated to the memory in each of the storage areas; and
a control unit which determines a storage area in which updated reference source information is different from reference source information which is recorded in the storage unit to be an area as a release target.

2. The calculator according to claim 1,
wherein the storage unit stores the updated reference source information when updating reference relations of the data.

3. The calculator according to claim 1,
wherein the control unit determines a storage area in which the updated reference source information is not included in reference source information which is recorded in the storage unit to be a release target area.

4. The calculator according to claim 1,
wherein the control unit further executes a releasing process of a storage area which is determined to be a release target, and
wherein the determination is executed when executing a releasing process of the storage area.

5. The calculator according to claim 4,
wherein the control unit executes the releasing process when it was not possible to generate data in the plurality of storage areas.

6. The calculator according to claim 1,
wherein at least identification information of reference source data or identification information of a storage area in which the reference source data is stored is included in the reference source information.

7. A non-transitory computer readable recording medium which stores a program which causes a calculator including an arithmetic unit and a memory to execute
a procedure of storing reference source information of data which is stored in a plurality of storage areas which are allocated to the memory in each of the storage areas; and
a procedure of determining a storage area in which updated reference source information is different from reference source information which is recorded in the storage unit to be an area as a release target.

8. A memory managing method used by a calculator comprising:
a step of storing reference source information of data which is stored in a plurality of storage areas which are allocated to a memory in each of the storage area; and
a step of determining a storage area in which updated reference source information is different from reference source information which is recorded in the storage unit to be an area as a release target.
